(19) United States
(12) Patent Application Publication
(10) Pub. No.: US 2019/0099701 A1
(43) Pub. Date: Apr. 4, 2019

(54) System and Method for Removing Solid Buildup from Filters

(71) Applicants: Larry Baxter, Orem, UT (US); Skyler Chamberlain, Provo, UT (US); Kyler Stitt, Lindon, UT (US); Aaron Sayre, Spanish Fork, UT (US); Jacom Chamberlain, Provo, UT (US); Nathan Davis, Bountiful, UT (US)

(72) Inventors: Larry Baxter, Orem, UT (US); Skyler Chamberlain, Provo, UT (US); Kyler Stitt, Lindon, UT (US); Aaron Sayre, Spanish Fork, UT (US); Jacom Chamberlain, Provo, UT (US); Nathan Davis, Bountiful, UT (US)

(21) Appl. No.: 15/720,278

(22) Filed: Sep. 29, 2017

(51) Int. Cl. B01D 29/62; B01D 29/35; B01D 37/04

(52) U.S. Cl. CPC B01D 29/62; B01D 2201/08; B01D 37/043; B01D 29/356

(57) ABSTRACT

A system and a method for removing solid buildup from a filter media is disclosed. A slurry is passed parallel across a cross-flow filter, the filter comprising a conductive filter media and the slurry comprising a carrier liquid and solids. A portion of the carrier liquid crosses through the filter media as a permeate while a thickened slurry continues parallel to the filter media. A blockage of at least a portion of the filter media is detected. The blockage comprises a portion of the solids. At least a portion of the filter media is heated to a melting temperature of the solids, such that a portion of the blockage melts, whereby the blockage is cleared.

### GOVERNMENT INTEREST STATEMENT

This invention was made with government support under DE-FE0028697 awarded by the Department of Energy. The government has certain rights in the invention.

### FIELD OF THE INVENTION

The devices, systems, and methods described herein relate generally to filtering solids. More particularly, the device, systems, and methods described herein relate to filtering solids near their melting point.

### BACKGROUND

Industrial applications require removal of solids from fluids in a wide variety of applications. Methods for solids removal can range from the simplicity of decanting, to the complexity of dissolution and later precipitation. The vast majority of solid/liquid removals occur through filters. Filter media universally share one trait—solids will, eventually, clog them. Cross-flow filters were developed to fight this tendency. Even though cross-flow filters, both with and without scraping devices, are better than dead-end filters for not clogging, the solids eventually block cross-flow filters, too. A system and method for removing solid buildup from filters is needed.

### SUMMARY

A system and a method for removing solid buildup from a filter media is disclosed. A slurry is passed parallel across a cross-flow filter, the filter comprising a conductive filter media and the slurry comprising a carrier liquid and solids. A portion of the carrier liquid crosses through the filter media as a permeate while a thickened slurry continues parallel to the filter media. A blockage of at least a portion of the filter media is detected. The blockage comprises a portion of the solids. The filter media is heated to a temperature that melts a portion of the blockage, whereby the blockage is cleared.

An instrument may detect the blockage and transmit a signal regarding the blockage. A processor may be configured to receive the signal from the instrument and control a heating device to heat the filter media.

Heating the filter media may comprise applying an electric current to the filter media, resulting in resistive heating or applying an induced current to the filter media, resulting in resistive heating. The portion of the blockage that melts may be adjacent to the filter media and the filter media may be heated for a duration not longer than sufficient to melt the portion of the blockage. A backpressure may be supplied to a downstream side of the filter media during heating sufficient to stop any of the solid that melts from crossing the filter media.

The carrier liquid may comprise water, hydrocarbons, liquid ammonia, liquid carbon dioxide, cryogenic liquids, or combinations thereof. The solids may comprise carbon dioxide, nitrogen oxide, sulfur dioxide, nitrogen dioxide, sulfur trioxide, hydrogen sulfide, hydrogen cyanide, water, mercury, hydrocarbons, or combinations thereof. The conductive filter media may comprise metal, conductive ceramics, conductive polymers, or combinations thereof.

The cross-flow filter may comprise a cross-flow thickener, a screw-press filter, a double-walled pipe filter, a pump filter, or a combination thereof.

Detecting the blockage may comprise measuring a drop of a flow rate of the permeate with a flow meter, measuring a drop of a flow rate of the thickened slurry with a flow meter, measuring an increase in a backpressure on the slurry with a pressure sensor, or a combination thereof. A signal may be received by a controller regarding the blockage and the controller may control one or more heating elements to start heating the filter media. Each heating element may heat a separate section of the filter media and may heat them in a sequence.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A-B show a cross-section of a cross-flow filter medium without and with blockage.

FIG. 2A-B show an isometric cutaway view and an end-on cross-sectional view of a double-walled pipe cross-flow filter.

FIGS. 3A-C show an isometric, exploded x-ray view, an isometric exploded view, and an isometric view of a thickening cross-flow filter assembly.

FIG. 4 shows an isometric cutaway view of a filtering screw-press.

FIGS. 5A-C show cross-sectional views of a filtering piston pump.

FIG. 6 shows an isometric cutaway view of a filtering double-screw pump.

FIG. 7 shows a method for removing solid buildup from a filter medium.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

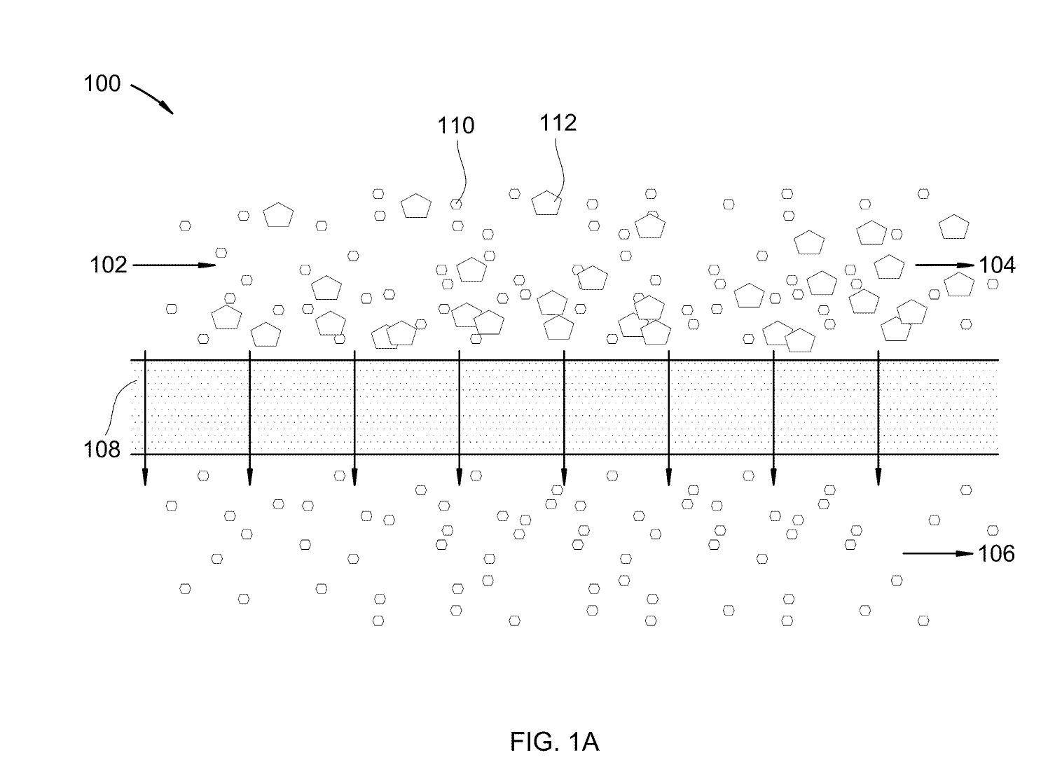

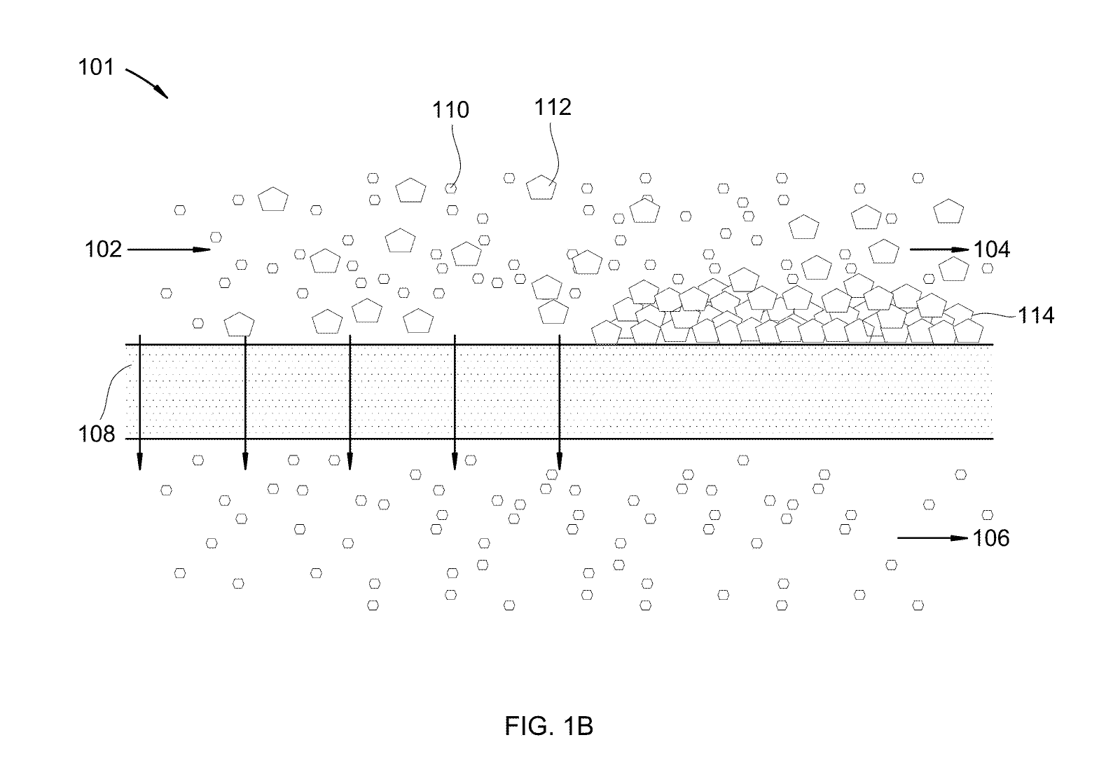

Referring to FIG. 1, a cross-section of a cross-flow filter medium is shown without blockage at 100 and with blockage at 101, as per one embodiment of the present invention. Slurry 102 passes parallel across filter medium 108. Filter medium 108 is conductive. Slurry 102 comprises solids 112 and carrier liquid 110. A portion of carrier liquid 110 crosses through filter media 108 as permeate 106. The remainder continues as thickened slurry 104. Blockage 114 forms on a portion of filter medium 108 as solids 112 build up on filter medium 108. Blockage 114 is detected by an instrument which transmits a signal regarding the blockage. A processor is configured to receive the signal from the instrument. The processor controls a heating device to heat filter medium 108 to a temperature that melts a portion of blockage 114. In this manner, blockage 114 is cleared. In other embodiments, only a portion of filter medium 108 is heated.

In some embodiments, detecting the blockage comprises measuring a drop of a flow rate of the permeate, measuring a drop of a flow rate of the thickened slurry, measuring an increase in a backpressure on the slurry, or a combination thereof. In some embodiments, a signal is received regarding the blockage and a heating element is controlled to start heating the filter media. In some embodiments, a plurality of heating elements are used, each heating a separate section of the filter media. In some embodiments, each of the separate sections are heated in a sequence. In some embodiments, a controller is used. In some embodiments, a flow meter, a pressure sensor, or a combination thereof are used to make measurements regarding blockage.

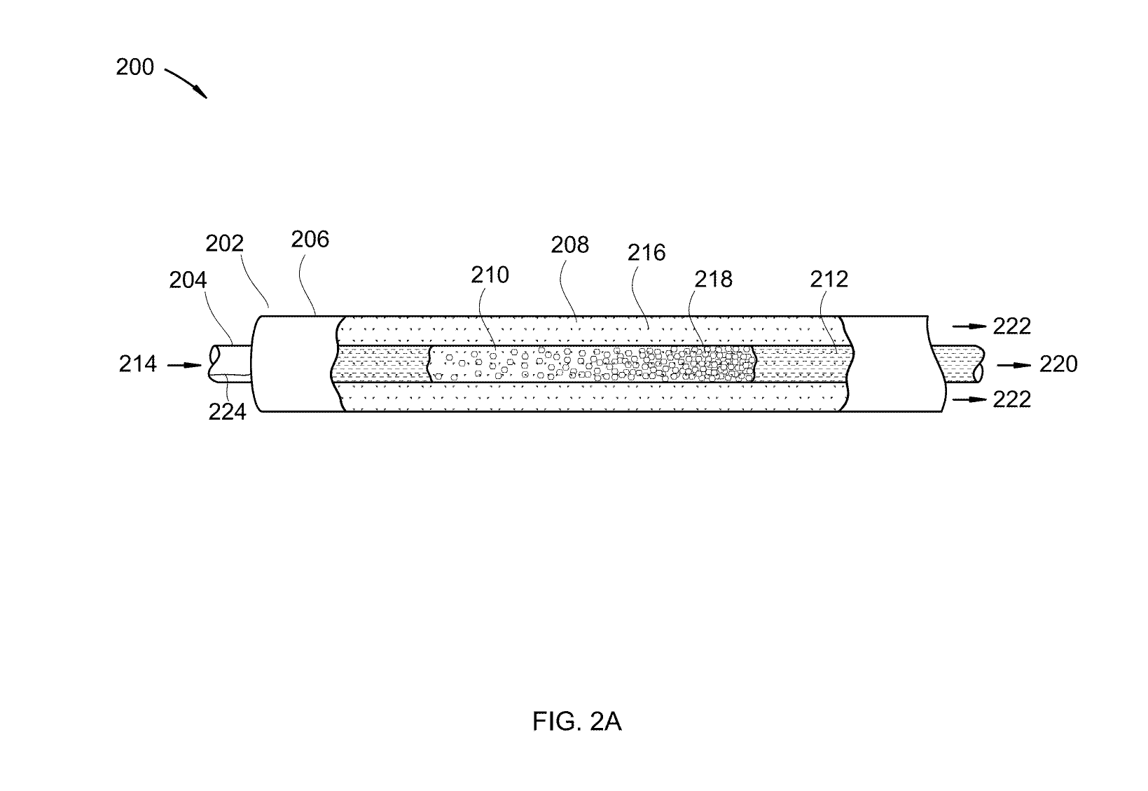

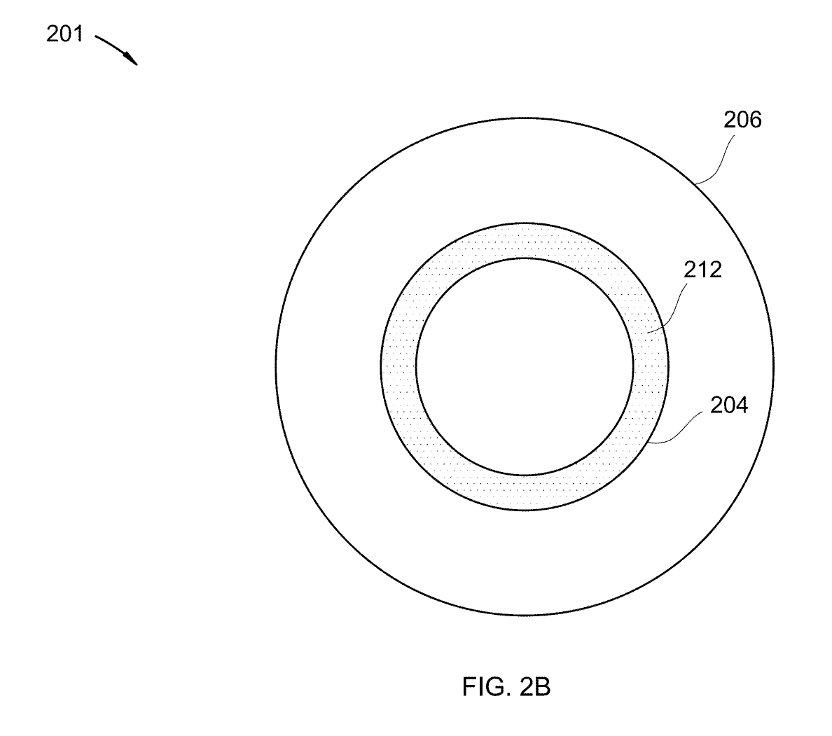

Referring to FIGS. 2A-B, an isometric cutaway view of a double-walled pipe cross-flow filter is shown at 200, with an end-on cross-sectional view shown at 201, as per one embodiment of the present invention. The double-walled pipe cross-flow filter 202 comprises inner pipe 204 and outer pipe 206, with a liquid plenum between them, the liquid plenum defining permeate discharge path 208. The space inside the inner pipe defines slurry flow path 210. Inner pipe 204 has cylindrical walls that form filter medium 212. Filter medium 212 is conductive. Slurry 214, comprising liquid 216 and solids 218, is provided to slurry flow path 210 and is thickened by cross-flow filtration to produce thickened slurry 220 by removal of the liquid through filter medium 212, producing permeate 222. A blockage of filter media 212 by a portion of solids 218 reduces the filtration efficiency of filter 202. The blockage is detected. Filter media 212 is heated by resistance heating through electrical input 224. Filter media 212 is heated to a temperature that melts a portion of the blockage, whereby the blockage is cleared.

In some embodiments, the double-walled pipe defines a generally spiral flow pattern. In other embodiments, the double-walled pipe defines a u-tube bundle pattern. In some embodiments, slurry flow path 210 and permeate discharge path 208 are switched. In some embodiments, inner pipe 204 forms a spiral or u-tube bundle pattern inside of outer pipe 206.

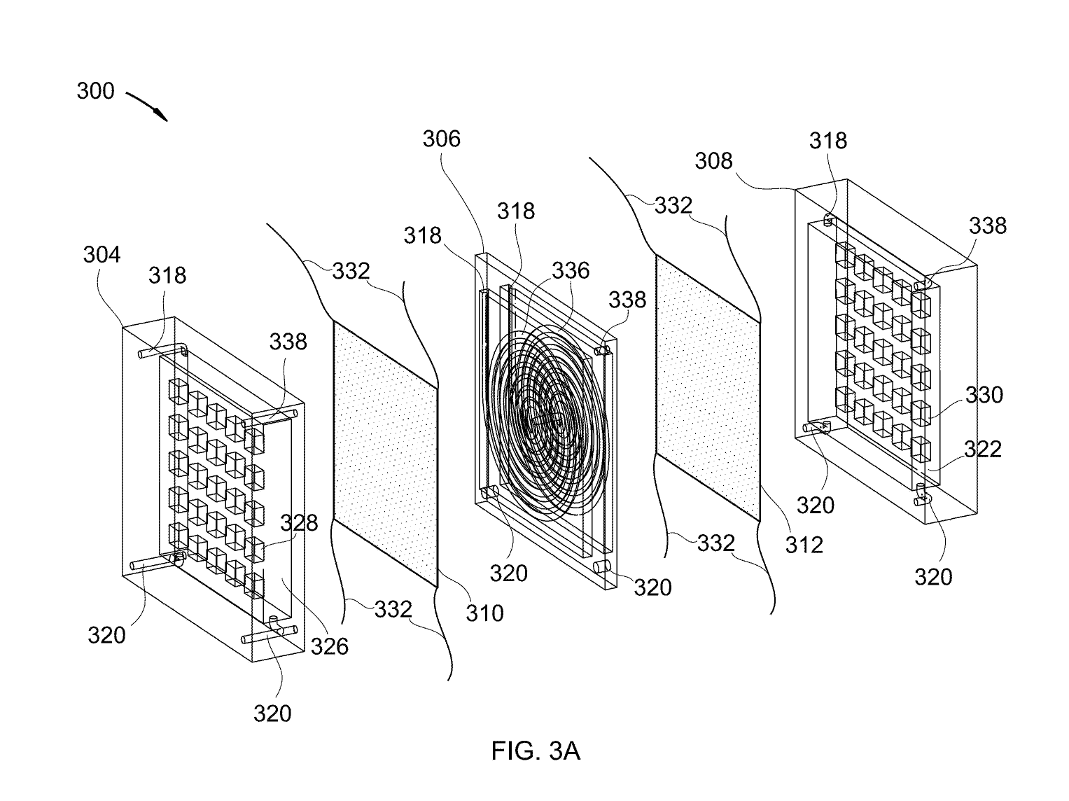

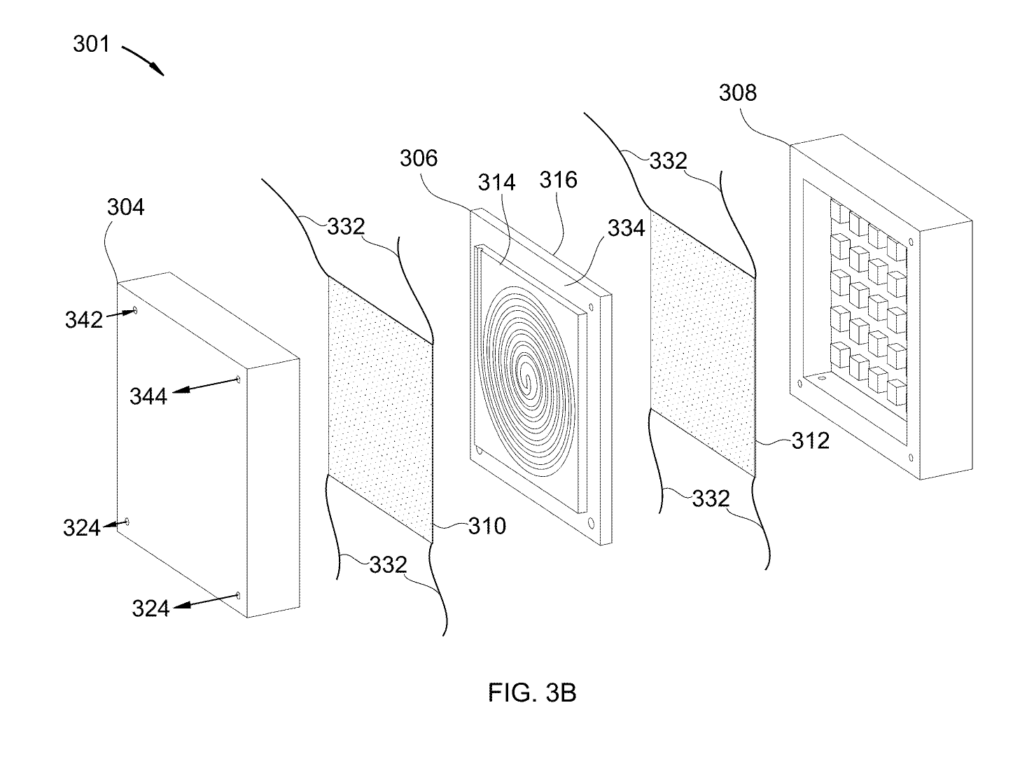

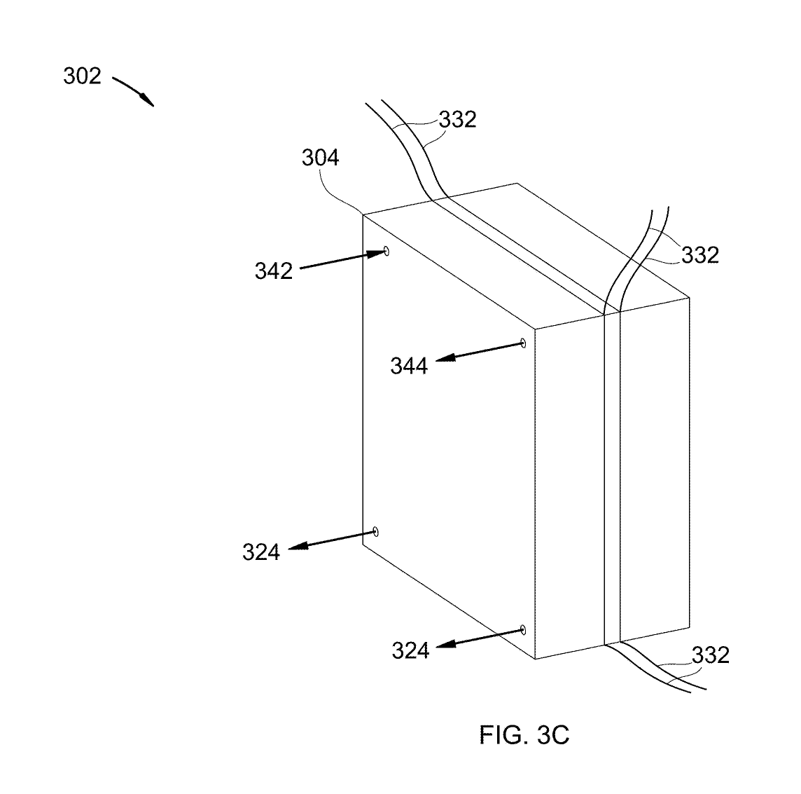

Referring to FIGS. 3A-C, an isometric, exploded x-ray view, an isometric exploded view, and an isometric view of a thickening cross-flow filter assembly at 300, 301 and 302, respectively, as per one embodiment of the present invention. The device comprises head plate 304, slurry plate 306, end plate 308, and a conductive filter medium, the filter medium further comprising first filter plate 310 and second filter plate 312. First filter plate 310 is secured between head plate 304 and first face 314 of slurry plate 306. Second filter plate 312 is secured between second face 316 of slurry plate 306 and end plate 308. Slurry flow path 318 passes through head plate 304 and slurry plate 306 into end plate 308, connecting to thickened slurry flow path 338 in end plate 308. Thickened slurry flow path 338 leaves end plate 308 and passes through slurry plate 306 and head plate 304. Permeate discharge path 320 begins in end plate 308 in end plate permeate removal chamber 322 and passes through slurry plate 306 and head plate 304, with additional liquid 324 provided to permeate discharge path 320 in head plate 304 by head plate permeate removal chamber 326. Slurry flow path 318 in the slurry plate comprises generally spiraling paths 336 on first face 314 of slurry plate 306 and second face 316 of slurry plate 306, wherein slurry flow path 318 is shaped generally like a half-pipe, with an open face of the half-pipe facing first filter plate 310 and second filter plate 312. Head plate 304 comprises raised lip 328 to insert first filter plate 310 such that an open space is provided between first filter plate 310 and head plate 304, the open space defining head plate permeate removal chamber 326. End plate 308 comprises raised lip 330 to insert second filter plate 312 such that an open space is provided between second filter plate 312 and end plate 308, the open space defining end plate permeate removal chamber 332. Slurry plate 306 comprises central portion 334 with generally spiraling paths 336, central portion 334 rimmed with narrower outside portion 340. Head plate 304 and end plate 308 are shaped in a manner that they will fit over central portion 334 of slurry plate 306, causing the combination of head plate 304, slurry plate 306, end plate 308, first filter plate 310, and second filter plate 312 to form a right rectangular prism. Slurry 342 passes through central portion 334 of slurry plate 306 generally tangential to first filter plate 310 and second filter plate 312, causing permeate 324 to pass into head plate permeate removal chamber 326 and end plate permeate removal chamber 332 and thickened slurry 344 to pass through thickened slurry flow path 338. Slurry 342 comprises a liquid and solids. A blockage of the filter media by a portion of the solids reduces the filtration efficiency of the filter media. The blockage is detected. First filter plate 310 and second filter plate 312 are heated by resistance heating through electrical inputs 332. The filter media are heated to a temperature that melts a portion of the blockage, whereby the blockage is cleared. In some embodiments, only a portion of plates 310 and 312 are heated (the plates 310 and 312 include multiple heating elements for heating different zones of the plates 310 and 312, for example).

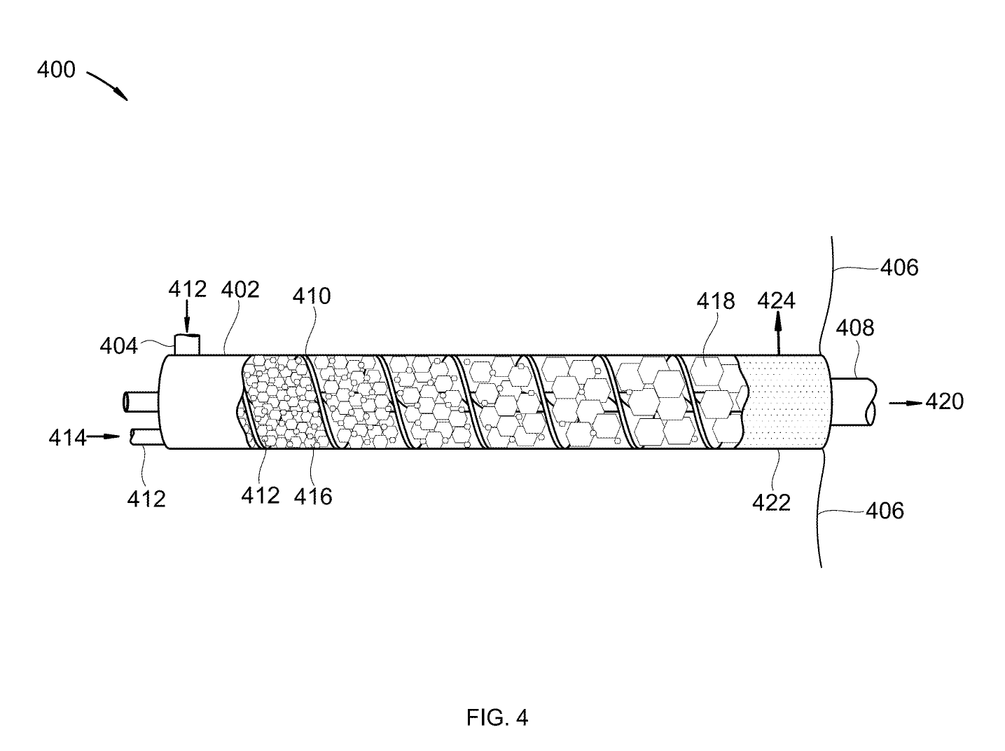

Referring to FIG. 4, an isometric cutaway view of a filtering screw-press is shown at 400, as per one embodiment of the present invention. Screw conveyor 402 comprises process inlet 406, solid inlet 404, product outlet 408, and filter 422. Second solids 412 are provided to screw conveyor 402 through solid inlet 404. Process fluid 414, comprising a process liquid and first solid 416, is provided to screw conveyor 402 through process inlet 406. Screw 410 advances process fluid 414 and second solids 412 through screw conveyor 402. First solids 416 adsorbs to, deposits on, fuses with, or is trapped by second solid 412, producing permeate 424 and first solid-loaded second solid 418. Permeate 424 is removed through filter 422. First solid-loaded second solid 418 is removed as product stream 420. A portion of product stream 420 is processed to reconstitute second solids 412, which is recycled to screw conveyor 402. A blockage of filter 422 by a portion of first and second solids 416 and 412 reduces the filtration efficiency of the filter media. The blockage is detected. Filter 422 is heated by resistance heating through electrical inputs 406. Filter 422 is heated to a temperature that melts a portion of the blockage, whereby the blockage is cleared. In some embodiments, only a portion of plates 310 and 312 are heated (the plates 310 and 312 include multiple heating elements for heating different zones of the plates 310 and 312, for example).

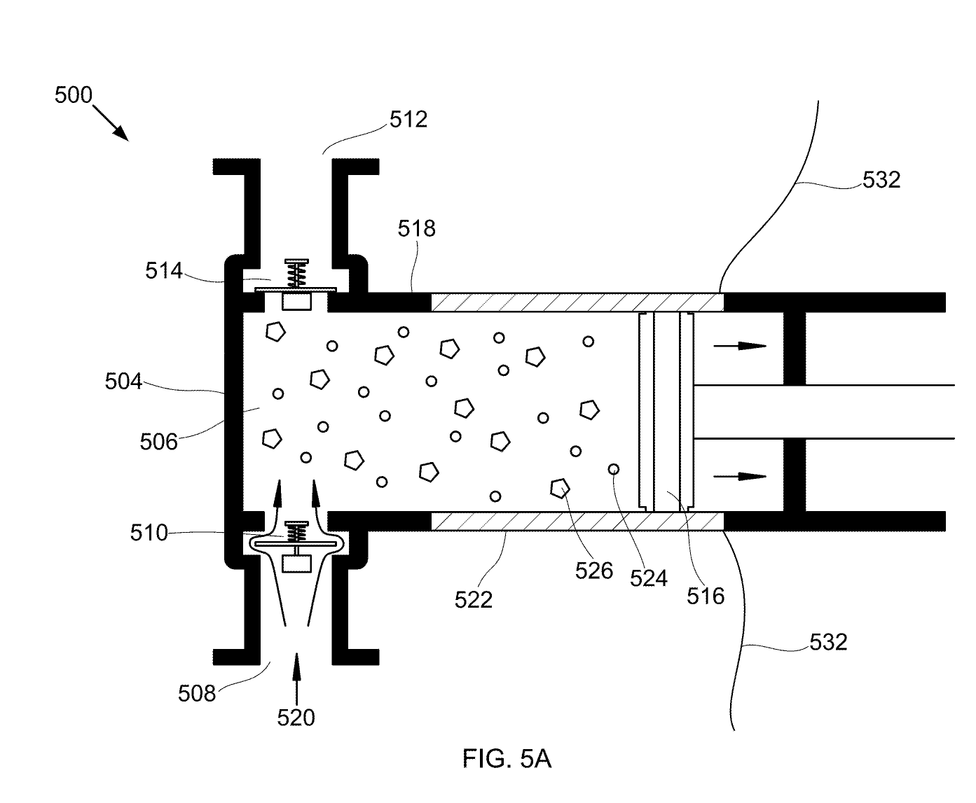

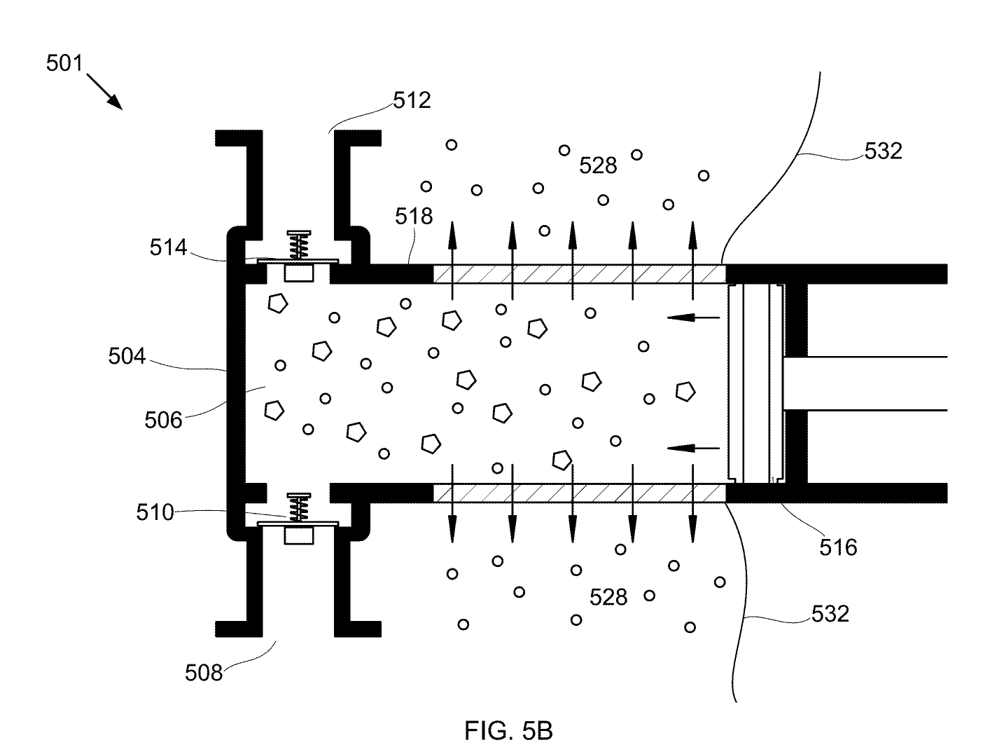

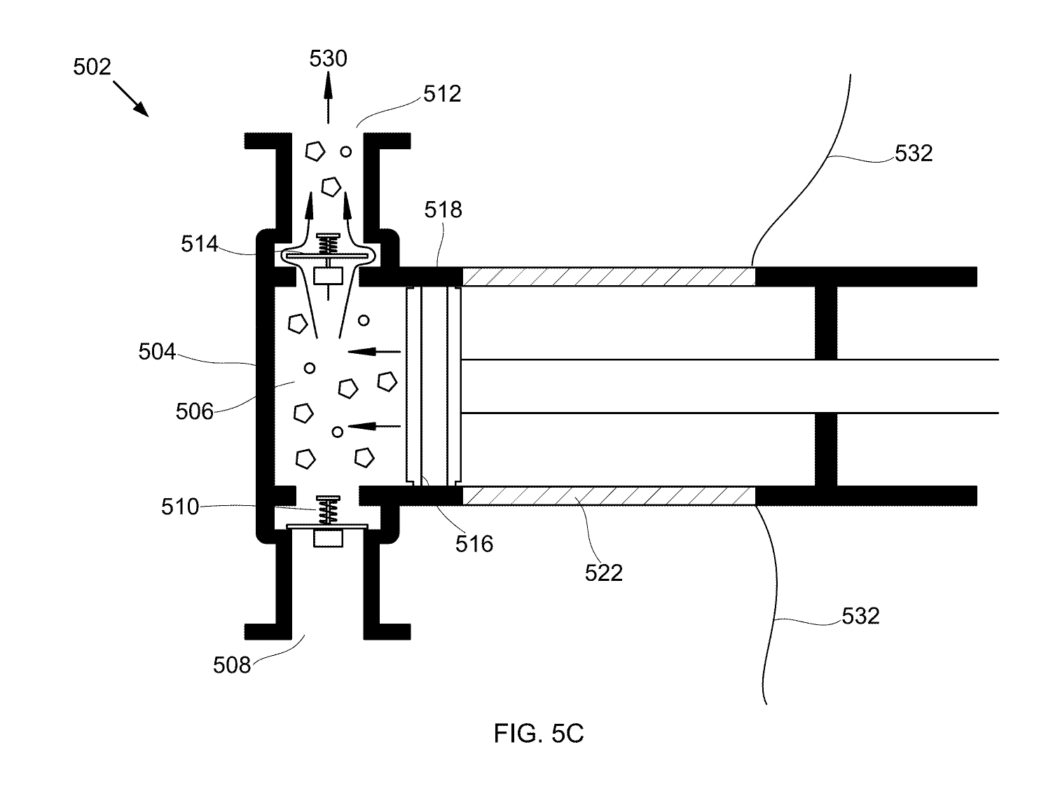

Referring to FIGS. 5A-C cross-sectional views of a filtering piston pump, during intake at 500, during filtration at 501, and during removal at 502, are shown, as per one embodiment of the present invention. Piston pump 504 comprises inner chamber 506, inlet 508, inlet valve 510, outlet 512, outlet valve 514, plunger 516, and external wall 518. Slurry 520, comprising liquid 524 and solid 526, is drawn through inlet 508 past open inlet valve 510 by suction from plunger 516 being drawn back. Inlet valve 510 is closed and plunger 516 is pushed forward into inner chamber 506, pressing a portion of liquid 524 across porous wall 522 as permeate 528, resulting in thickened slurry 530 inside of inner chamber 506. Outlet valve 514 is opened and plunger 516 continues into inner chamber 506, pushing a portion of thickened slurry 530 past outlet valve 514 and through outlet 512. The cycle is then repeated. A blockage of porous wall 522 by a portion of solids 526 reduces the filtration efficiency of porous wall 522. The blockage is detected. At least a portion of the porous wall 522 is heated by resistance heating through electrical inputs 532. Porous wall 522 is heated to a temperature that melts a portion of the blockage, whereby the blockage is cleared.

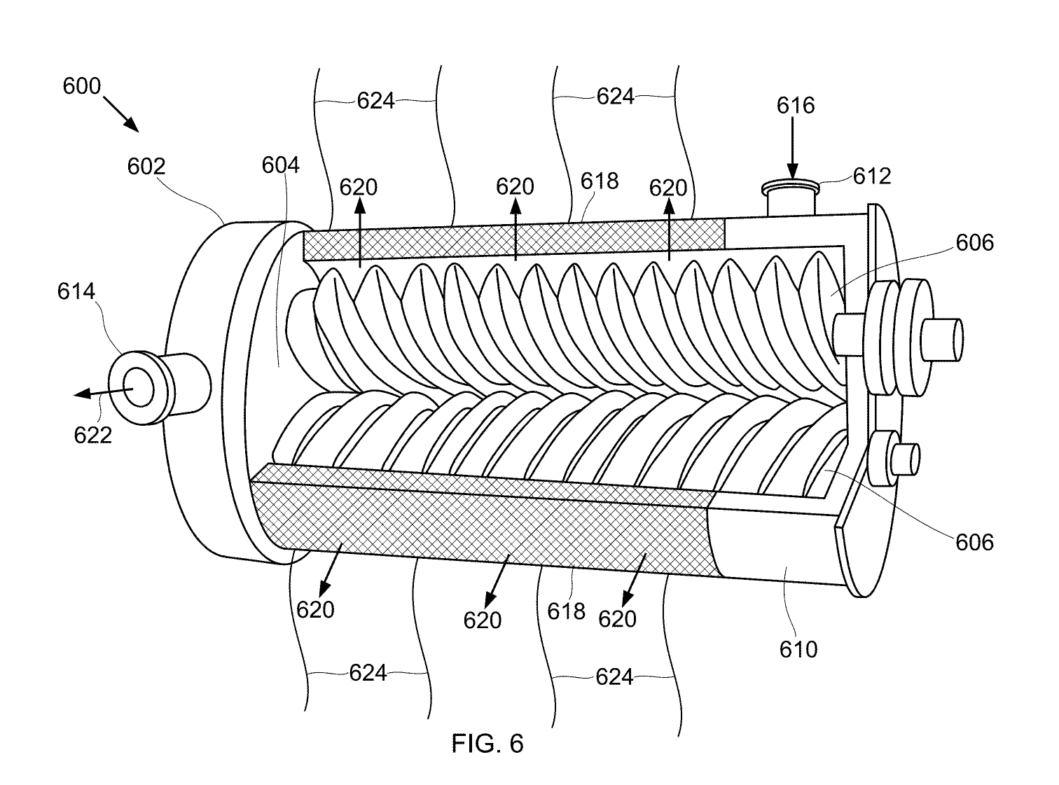

Referring to FIG. 6, an isometric cutaway view of a filtering double-screw pump is shown at 600, as per one embodiment of the present invention. Screw pump 602 comprises inner chamber 604, screws 606, external wall 610, inlet 612, and outlet 614. Slurry 616 is provided through inlet 612 to inner chamber 604. Slurry 616, comprising a liquid and solids, is pumped and pressurized through inner chamber 604 across a portion of external wall 610, the portion comprising porous wall 618, by the pumping apparatus, comprising screws 606. Screws 606 narrow between the inlet and the outlet, resulting in less volume for the slurry, pressurizing slurry 616, causing a portion of the liquid to be pressed across porous wall 618 as permeate 620. The removal of the liquid causes slurry 616 to be thickened to thickened slurry 622. Thickened slurry 622 leaves screw pump 602 through outlet 614. A blockage of porous wall 618 by a portion of the solids reduces the filtration efficiency of porous wall 618. The blockage is detected. At least a portion of the porous wall 618 is heated by resistance heating through electrical inputs 624. Porous wall 618 is heated to a temperature that melts a portion of the blockage, whereby the blockage is cleared.

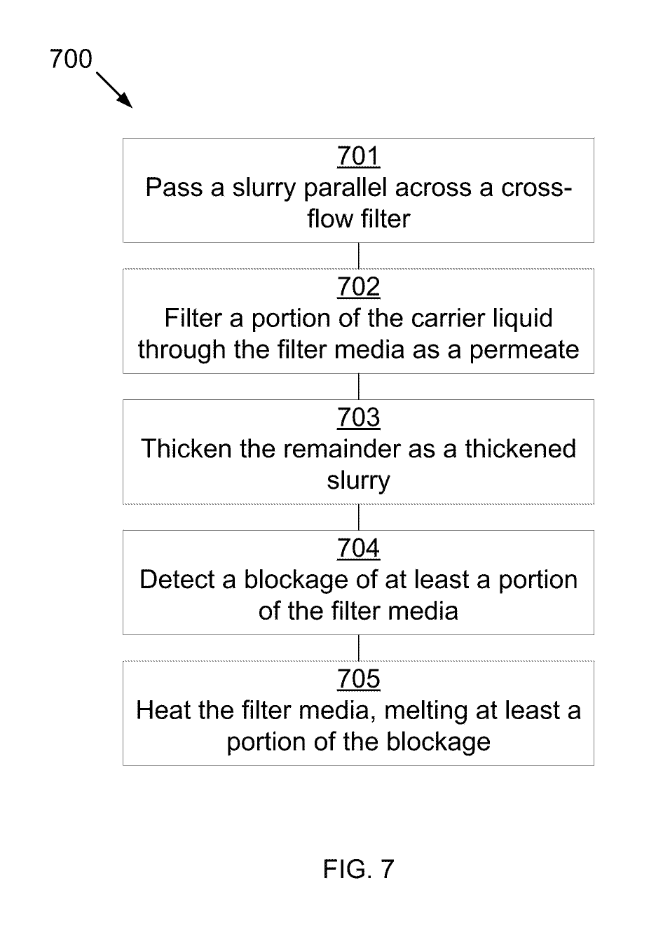

Referring to FIG. 7, a method for removing solid buildup from a filter medium is shown at 700, as per one embodiment of the present invention. A slurry is passed parallel across a cross-flow filter 701. The filter comprises a conductive filter media and the slurry comprises a carrier liquid and solids. A portion of the carrier liquid crosses through the filter media as a permeate 702 while a thickened slurry continues parallel to the filter media 703. A blockage of at least a portion of the filter media is detected 704. The blockage comprises a portion of the solids. At least a portion of the filter media is heated to a temperature that melts a portion of the blockage 705. In this manner, the blockage is cleared.

In some embodiments, heating the filter media comprises applying an electric current to the filter media, resulting in resistive heating, or applying an induced current to the filter media, resulting in resistive heating. In some embodiments, the portion of the blockage that melts is adjacent to the filter media and the filter media is heated for a duration not longer than sufficient to melt the portion of the blockage. In some embodiments, a backpressure is supplied to a downstream side of the filter media during heating sufficient to stop any of the solid that melts from crossing the filter media. In some embodiments, only a portion of the filter media is heated.

In some embodiments, the carrier liquid comprises water, hydrocarbons, liquid ammonia, liquid carbon dioxide, cryogenic liquids, or combinations thereof. In some embodiments, the solids comprise carbon dioxide, nitrogen oxide, sulfur dioxide, nitrogen dioxide, sulfur trioxide, hydrogen sulfide, hydrogen cyanide, water, mercury, hydrocarbons, or combinations thereof. In some embodiments, the conductive filter media comprises metal, conductive ceramics, conductive polymers, or combinations thereof.

In some embodiments, the cross-flow filter comprises a cross-flow thickener, a screw-press filter, a double-walled pipe filter, a pump filter, or a combination thereof.

In some embodiments, detecting the blockage comprises measuring a drop of a flow rate of the permeate, measuring a drop of a flow rate of the thickened slurry, measuring an increase in a backpressure on the slurry, or a combination thereof. In some embodiments, a signal is received regarding the blockage and a heating element is controlled to start heating the filter media. In some embodiments, a plurality of heating elements are used, each heating a separate section of the filter media. In some embodiments, each of the separate sections are heated in a sequence. In some embodiments, a controller is used. In some embodiments, a flow meter, a pressure sensor, or a combination thereof are used to make measurements regarding blockage.

We claim:

1. A method for removing solid buildup from a filter media comprising:
passing a slurry parallel across a cross-flow filter, the filter comprising a conductive filter media and the slurry comprising a carrier liquid and solids, wherein a portion of the carrier liquid crosses through the filter media as a permeate while a thickened slurry continues parallel to the filter media;
detecting a blockage of at least a portion of the filter media, the blockage comprising a portion of the solids; and,
heating at least a portion of the filter media to a temperature that melts a portion of the blockage, whereby the blockage is cleared.

2. The method of claim 1, wherein heating the filter media comprises:
applying an electric current to the filter media, resulting in resistive heating; or,
applying an induced current to the filter media, resulting in resistive heating.

3. The method of claim 2, further comprising supplying a backpressure to a downstream side of the filter media during heating sufficient to stop any of the solid that melts from crossing the filter media.

4. The method of claim 1, wherein the carrier liquid comprises water, hydrocarbons, liquid ammonia, liquid carbon dioxide, cryogenic liquids, or combinations thereof.

5. The method of claim 1, wherein the solids comprise carbon dioxide, nitrogen oxide, sulfur dioxide, nitrogen dioxide, sulfur trioxide, hydrogen sulfide, hydrogen cyanide, water, mercury, hydrocarbons, or combinations thereof.

6. The method of claim 1, wherein the cross-flow filter comprises:
a cross-flow thickener;
a screw-press filter;
a double-walled pipe filter;
a pump filter; or,
a combination thereof.

7. The method of claim 1, wherein detecting the blockage comprises:
measuring a drop of a flow rate of the permeate;
measuring a drop of a flow rate of the thickened slurry;
measuring an increase in a backpressure on the slurry; or,
a combination thereof.

8. The method of claim 7, further comprising receiving a signal regarding the blockage and controlling a heating element to start heating the filter media.

9. The method of claim 7, further comprising receiving a signal regarding the blockage and controlling a plurality of heating elements to start heating the filter media, wherein each of the plurality of heating elements heats a separate section of the filter media.

10. The method of claim 9, further comprising starting each of the plurality of heating elements in a sequence.

11. A system for removing solid buildup from a filter media comprising:
a cross-flow filter comprising a conductive filter media, wherein a slurry is passed parallel to the cross-flow filter, the slurry comprising a carrier liquid and solids, a portion of the carrier liquid crossing through the filter media as a permeate while the thickened slurry continues parallel to the filter media;
an instrument detects a blockage of at least a portion of the filter media and transmits a signal regarding the blockage, wherein the blockage comprises a portion of the solids; and,
a processor, wherein the processor is configured to:
receive the signal from the instrument; and
control one or more heating devices to heat at least a portion of the filter media to a temperature that melts a portion of the blockage, whereby the blockage is cleared.

12. The system of claim 11, wherein the heating device heats the filter media by:
applying an electric current to the filter media, resulting in resistive heating; or,
applying an induced current to the filter media, resulting in resistive heating.

13. The system of claim 13, further comprising supplying a backpressure to a downstream side of the filter media during heating sufficient to stop any of the solid that melts from crossing the filter media.

14. The system of claim 11, wherein the carrier liquid comprises water, hydrocarbons, liquid ammonia, liquid carbon dioxide, cryogenic liquids, or combinations thereof.

15. The system of claim 11, wherein the solids comprise carbon dioxide, nitrogen oxide, sulfur dioxide, nitrogen dioxide, sulfur trioxide, hydrogen sulfide, hydrogen cyanide, water, mercury, hydrocarbons, or combinations thereof.

16. The system of claim 11, wherein the conductive filter media comprises metal, conductive ceramics, conductive polymers, or combinations thereof.

17. The system of claim 11, wherein the cross-flow filter comprises:
a cross-flow thickener;
a screw-press filter;
a double-walled pipe filter;
a pump filter; or,
a combination thereof.

18. The system of claim 11, wherein the instrument comprises:
a flow meter measuring a drop of a flow rate of the permeate;
a flow meter measuring a drop of a flow rate of the thickened slurry;
a pressure sensor measuring an increase in a backpressure on the slurry; or,
a combination thereof.

19. The system of claim 11, wherein each of the one or more heating elements heats a separate section of the filter media.

20. The system of claim 19, where each of the one or more heating elements are started in a sequence.
